(19) United States
(12) Patent Application Publication
(10) Pub. No.: US 2002/0160350 A1
(43) Pub. Date: Oct. 31, 2002

(54) System and method for controlling cooperation learning state

(76) Inventors: Tadashi Tanaka, Tachikawa (JP); Akihiko Koga, Yamato (JP); Hiroshi Tachibana, Yokohama (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/096,861

(22) Filed: Mar. 14, 2002

(30) Foreign Application Priority Data
Apr. 26, 2001 (JP) 2001-128617

(51) Int. Cl. G09B 3/00

(52) U.S. Cl. 434/350

(57) ABSTRACT

Interactive data for group A or collaborative learning work data for group A stores cooperation leaning data shared by a plurality of learners. In a learning state data updating process, requests for access to the group A interactive data or group A collaborative learning work data are detected in correspondence with a learner client and the number of access requests to the collaborative learning data is detected in correspondence with the learner client. In a learning state notifying process, access request numbers of a plurality of learner clients are compared with each other and a comparison result is notified to an instructor client and/or the learner client in accordance with the comparison result.

### CROSS-REFERENCE TO RELATED APPLICATION

This application relates to an application U.S. Ser. No. ______ filed on Jan. 31, 2002 entitled “ROLE MANAGED COLLABORATIVE LEARNING SUPPORT SYSTEM AND METHOD” based on Japanese Patent Application No. 2001-106628, filed on Apr. 5, 2001, and assigned to the present assignee. The content of that application is incorporated herein by reference.

### BACKGROUND OF THE INVENTION

The present invention relates to a cooperation or collaborative learning system for managing a collaborative learning state among a plurality of learners and a method for the same.

As a prior art, JP-A-10-214022 is available which discloses that on the basis of data acquired from cooperative behavior of a plurality of learners having a common learning subject, a learning history of an advanced learner is recorded to edit a group learning teaching material having the function of showing to a junior learner a procedure for getting to a target state, information concerning the learning subject is indicated while permitting other learners to share and utilize the edited group learning teaching material and the group learning teaching material is updated while fetching notes/memorandums of learners.

JP-A-10-214022, however, gives a mere disclosure of constructing the group learning teaching material and fails to manage to consider improving the leaning effects in group learning by utilizing the group learning teaching material.

As another prior art, JP-A-2000-99491 is available which discloses that a plurality of learners belonging to a group share a learning teaching material to proceed with learning while exchanging information inside the group, and a plurality of clients, having each two mechanisms of information interpreting mechanism for exchanging shared external information or group knowledge individually with internal information and an information extracting mechanism for extracting intermediate information individually from the internal information, have each a conversion step of converting the external information and group knowledge individually through the information interpreting mechanism, an extracting step of passing the internal information individually through the information extracting mechanism to extract the intermediate information and a cumulation step of causing a group knowledge cumulation system, having a group knowledge rearranging mechanism for adding the intermediate information from the client individually to the group knowledge, to add the intermediate information to the group knowledge.

JP-A-2000-99491, however, gives a mere disclosure of cumulating the group knowledge and fails to manage to consider improving the learning effects in group learning by utilizing the group knowledge.

### SUMMARY OF THE INVENTION

It is an object of the present invention to provide a collaborative learning system for improving the effects of collaborative learning among a plurality of learners and a method for the same.

According to an aspect of the invention, collaborative learning data shared by a plurality of learners is stored in a memory area, a request for accessing the cooperation leaning data is detected in correspondence with a learner and the request for accessing the collaborative learning data is calculated in correspondence with the learner. Preferably, numbers of access requests by the plurality of learners are compared with each other and a comparison result is notified and/or transmitted by electronic mail to an instructor and/or learners in accordance with the comparison result.

Alternatively, according to another aspect of the invention, collaborative learning data shared by a plurality of learners is stored in a memory area, a time point of starting accessing the collaborative learning data and a time point of ending accessing the collaborative learning data are detected in correspondence with a learner and a time for the learner to participate in collaborative learning is calculated in correspondence with the learner. Then, preferably, access times of the plurality of learners are compared with each other and a comparison result is notified and/or transmitted by electronic mail to an instructor and/or learners in accordance with the comparison result.

The aspect of the present invention can attain an advantage that a deviation among the plurality of learners can be discriminated and the cooperation leaning can be proceeded with by making reference to the deviation to improve the effects of collaborative learning among the plurality of learners.

Another aspect of, the present invention can attain an advantage that a deviation among the plurality of learners can be discriminated and the deviation is notified to a manager for managing collaborative learning among the plurality of learns to mitigate the management load on the manager and permit the manager to guide or replace learners by making reference to the deviation, thereby improving the effects of collaborative learning among the plurality of learners.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing the construction of a collaborative learning system according to an embodiment of the present invention.

FIG. 2 is a diagram showing the hardware construction of learner client, instructor client and cooperation leaning server in the embodiment.

FIG. 3 is a data table of interactive data for an arbitrary group in the embodiment.

FIG. 4 is a data table of collaborative work data for an arbitrary group in the embodiment.

FIG. 5 is a data table of learning state data in the embodiment.

FIG. 6 is a data table of learning group data in the embodiment.

FIG. 7 is a data table of learning scenario data in the embodiment.

FIG. 8 is a data table of learning management data in the embodiment.

FIG. 9 is a data structure diagram of data of a request for operation on a learning resource transmitted from the learner client to the collaborative learning server in the embodiment.

FIG. 10 is a flowchart of a shared learning area accessing process in the embodiment.

FIG. 11 is a flowchart of a learning state data updating process in the embodiment.

FIG. 12 is a flowchart of a learning state notifying process in the embodiment.

FIG. 13 is a data table of another example of learning scenario data in the embodiment.

### DETAILED DESCRIPTION OF THE EMBODIMENTS

The invention will now be describe by way of example with reference to the accompanying drawings.

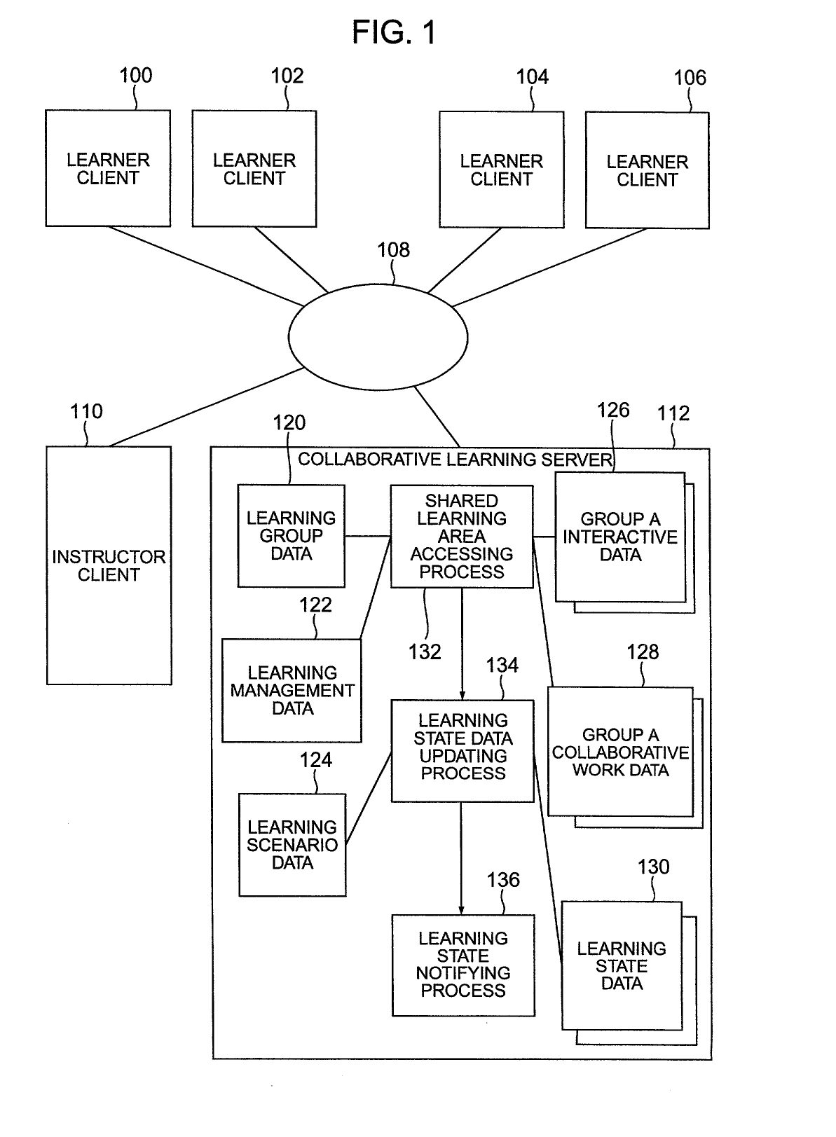

FIG. 1 diagram matically shows the overall construction of a collaborative learning system according to an embodiment of the invention. The collaborative learning system comprises learner clients 100 to 106 used by learners, an instructor client 110 used by an instructor guiding the learners, a collaborative learning server 112 necessary for the learners to conduct collaborative learning, and a network 108 for transmitting/receiving data among the learner clients 100 to 106, instructor client 110 and collaborative learning server 112.

A plurality of learner clients 100 to 106 connect to the collaborative learning server 112 through the network 108. Each learner makes a request from a learner client of its own to the collaborative learning server 112 for access to data for a learning group, to which the learner belongs, of interactive data and collaborative work data stored in the collaborative learning server 112 and conducts collaborative learning. The data for a learning group to which the learner belongs is accessible (writable and readable) by the learner belonging to the group. A plurality of learner groups coexist at a time but in this example, it is assumed that the learner belongs to a learning group called “group A”. Accordingly, the learner can access interactive data 126 for group A and collaborative work data 128 for group A to conduct learning in the group.

The instructor client 110 used by an instructor for managing or guiding learning is also connected to the collaborative learning server 112 through the network 108. The instructor makes a request from the instructor client 110 to the collaborative learning server 112 for access to learning group data 120, learning management data 122 and learning scenario data 124 so as to prepare and update the data. The learning group data 120 is necessary for the instructor to prepare individual learning groups and is set with constituent members and the role of each member. The learning management data 122 is data for setting contents of learning which the instructor causes the learning group to conduct. Further, the learning scenario data 124 is data necessary for the instructor to set details of the learning contents so that the contents of learning may be classified into more detailed steps and conditions for learning activities in each step may be set. Before enabling the leaner to conduct collaborative learning, the instructor carries out setting of the above data as management work for learning.

When collaborative learning is started, a learner makes a request from the learner client 100 to the collaborative learning server 112 for access to the group A interactive data 126 and group A collaborative work data 128. Receiving the request, the collaborative learning server 112 executes a shared learning area accessing process 132. In the shared learning area accessing process 132, a learning group to which the learner, that is, requester belongs is decided by consulting the learning management data 122 and learning group data 120, access to data for that learning group is carried out and a result is returned to the learner client 100.

The access request from the learner clients 100 to 106 to the collaborative learning server 112 is set with a log-in request during learning start and a log-out request during learning end in order that a log-in time (a time point of starting access to collaborative learning) and a log-out time (a time point of ending access to collaborative learning) can be measured in correspondence with the individual learners and the measured times can be stored in the learning management data 122. An interval of time between log-in and log-out is defined as a time for each learner to participate in learning and is used for decision of notification condition and end condition.

When the shared learning area accessing process 132 ends, the collaborative learning server 112 sequentially executes a learning state data updating process 134. In the learning state data updating process 134, learning state data 130 is updated on the basis of the access request received in the shared learning area accessing process 132 and a progression condition for learning phase described in the learning scenario data 124.

Further, if required to do so as a result of the learning state data updating process 134, the collaborative learning server 112 transmits by electronic mail for instance a learning state of a group to the instructor client 110 for an instructor in charge of the group by way of a learning state notifying process 136.

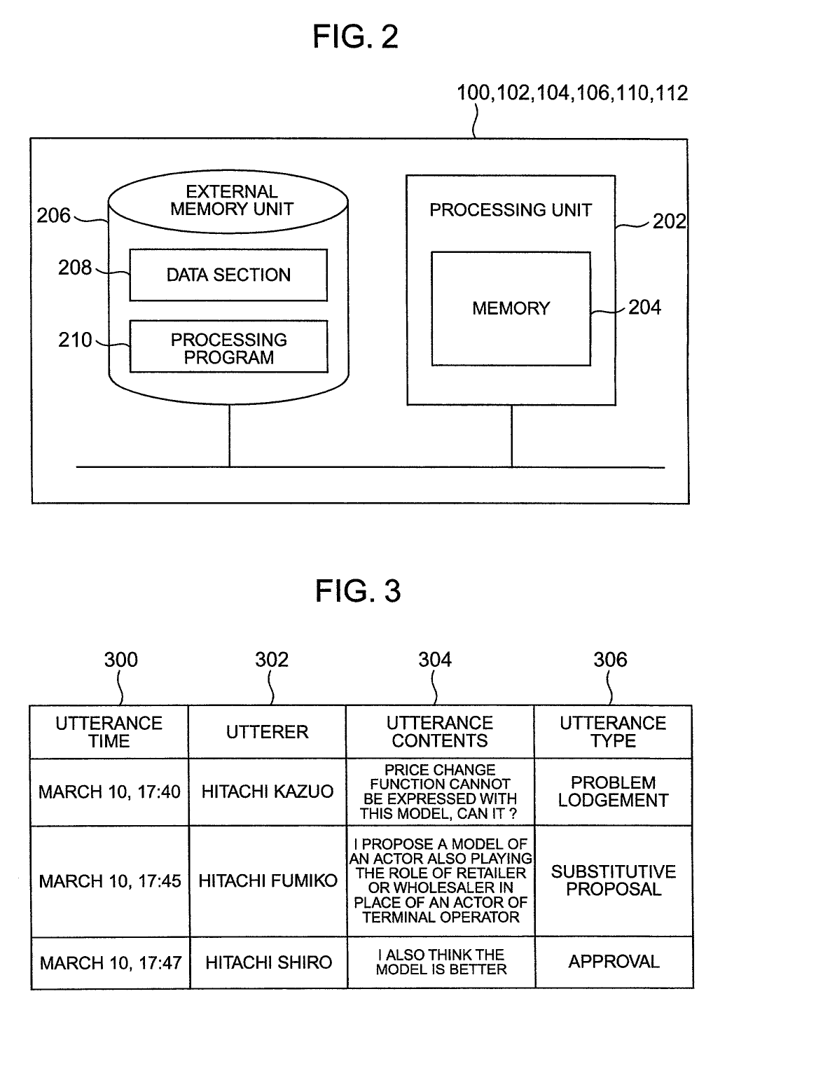

FIG. 2 is a hardware construction diagram of each of the learner clients 100 to 106, instructor client 110 and collaborative learning server 112.

In the collaborative learning server 112, the learning group data 120, learning management data 122, learning scenario data 124, group A interactive data 126, group A collaborative work data 128 and learning state data 130 are stored in a data section 208 of external memory unit 206. Stored in a processing program 210 are processing programs for the shared learning area accessing process 132, learning state data updating process 134 and learning state notifying process 136. The function presented by the present system can be realized by causing a processing unit 202 of the collaborative learning server 112 receiving a request from the client to read the data section 208 and processing program 210 of the external memory unit 206 and write them in a memory 204 so as to carry out a process and by returning a result to the client.

The collaborative learning server 112 may include a web server for receiving a request from the learner clients 100 to 106 and instructor client 110 and transmitting a HTML (hypertext markup language) file in accordance with a URL (uniform resource locator) contained in the request, an application server for operating application programs and a database server for storing data. The collaborative learning server 112 may further include a file server for storing files and a mail server for transmitting electronic mail.

Each of the learner clients 100 to 106 and instructor client 110 may be, for example, a general personal computer (including an operation processing unit such as CPU, a memory unit such as hard disk and memory, a display unit such as CRT display or liquid crystal display, an input unit such as keyboard or mouse and a communication control unit such as modem) or a portable information terminal (inclusive of a portable telephone). In the learner clients 100 to 106 and instructor client 110, a program stored in the memory unit is executed by the operation processing unit. Each of the learner clients 100 to 106 and instructor client 110 may have the web browser function of converting a HTML file.

FIG. 3 shows an example of the group A interactive data 126. The group A interactive data 126 stores data of an interaction carried out in collaborative learning in the learning group called “group A”. Stored in utterance time 300 is a date and time at which a learner contributed an utterance. Stored in utterer 302 is a name of an utterer who contributed the utterance. Stored in utterance contents 304 is contents of the contributed utterance. Stored in utterance type 306 is a value of type of the utterance of its own designated by the learner. The type of utterance indicates an intention of the utterer or a meaning of the utterance given in discussion. Preferably, the utterance type is designated by the utterer at the time that the utterance is given. In the example of FIG. 3, an utterance for pointing out problems involved in the current proposal is allotted with a type of “problem lodgement”, an utterance for presenting a substitutive proposal to solve the pointed out problem is allotted with a type of “substitutive proposal” and an utterance for approving an opinion of the preceding utterer is allotted with a type of “approval”.

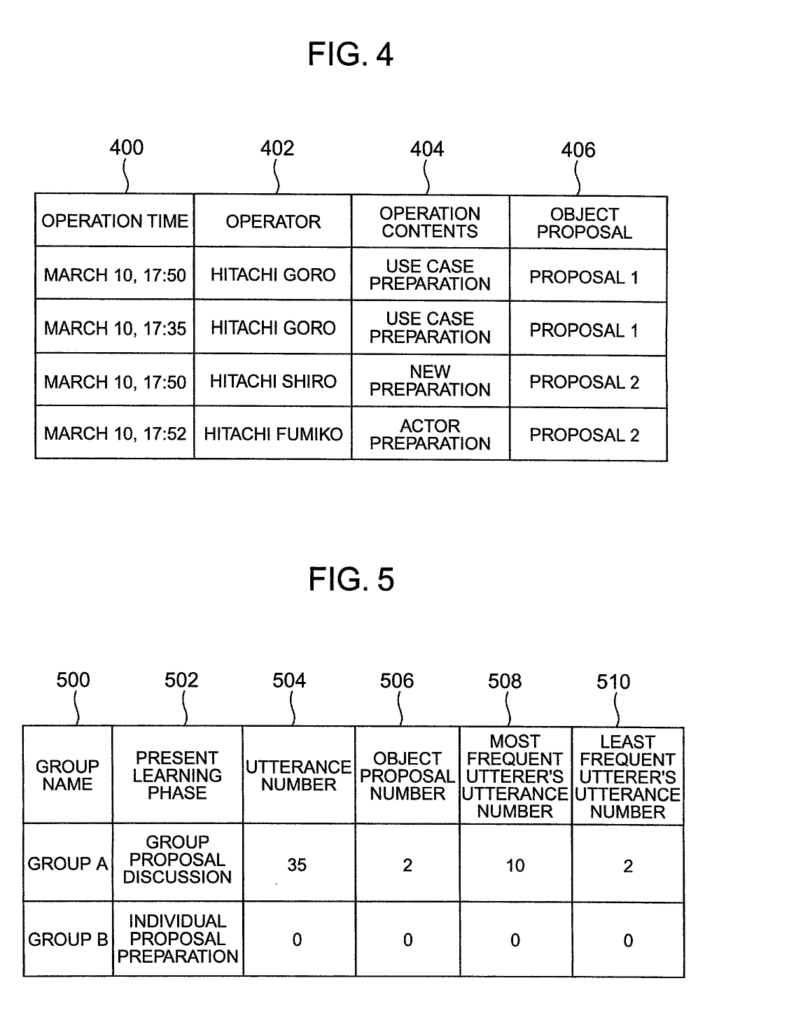

FIG. 4 shows an example of the group A collaborative work data 128. The group A collaborative work data 128 stores data of collaborative work carried out in collaborative learning in the learning group called “group A”. Stored in operation time 400 is a date and time at which a learner applied an operation to a collaborative work area. Stored in operator 402 is a name of the operator who applied the operation. Stored in operation contents 404 is contents of the applied operation. Stored in object proposal 406 is a name of a proposal that is an object to be operated in the collaborative work area when the operation is applied. In FIG. 4, a partial example is shown in which collaborative work is first carried out by using “proposal 1” as object and thereafter “proposal 2” is about to be prepared as substitutive proposal.

FIG. 5 shows an example of the learning state data 130. In the learning state data 130, data concerning a state of collaborative learning of each learning group is stored. Stored in group name 500 is a group name of a learning group (for example, “group A”) that is conducting collaborative learning at present. Stored in present learning phase 502 is a learning phase reached at present in respect of each group. Stored in utterance number 504 is a total of utterances contributed to an interactive tool by members of a learning group till then. Through the learning state data updating process, an utterance of each learner is detected and an utterance number 504 is calculated. It is to be noted that a total of utterances given over the individual learning phases may also be used. Stored in object proposal number 506 is the number of proposals to be discussed in a discussion held by using a collaborative work tool. Through the learning data updating process, proposals by each learner subjected to a discussion are detected and the number of discussed proposals is calculated. Stored in most frequent utterer's utterance number 508 is a total of utterances given till then by a learner who gave a maximal number of utterances when utterances in a learning group are totaled in respect of each learner. Through the learning state data updating process, the total of utterances by the learner who gave till then the maximal number of utterances are calculated. Stored in least frequent utterer's utterance number 510 is a total of utterances given till then by a learner who gave a minimal number of utterances when utterances in the learning group are totaled in respect of each learner. Through the learning state data updating process, the total of utterances by the learner who gave till then the minimal number of utterances are calculated. In the example of FIG. 5, the most frequent utterer's utterance number 508 and the least frequent utterer's utterance number are provided as data items. This is for aiming at evaluating a deviation in utterance numbers by learners in the learning group by using the ratio between a value of the most frequent utterer's utterance number and a value of the least frequent utterer's utterance number. The data items concerning learning activities in the learning state data 130 shown in this example are not limitative. The data item may be changed in accordance with a learning state to be monitored by, for example, providing a data item for storing number of times of utterances sorted by the type to regulate the notification condition and end condition depending on a number of times of utterances of a specified type.

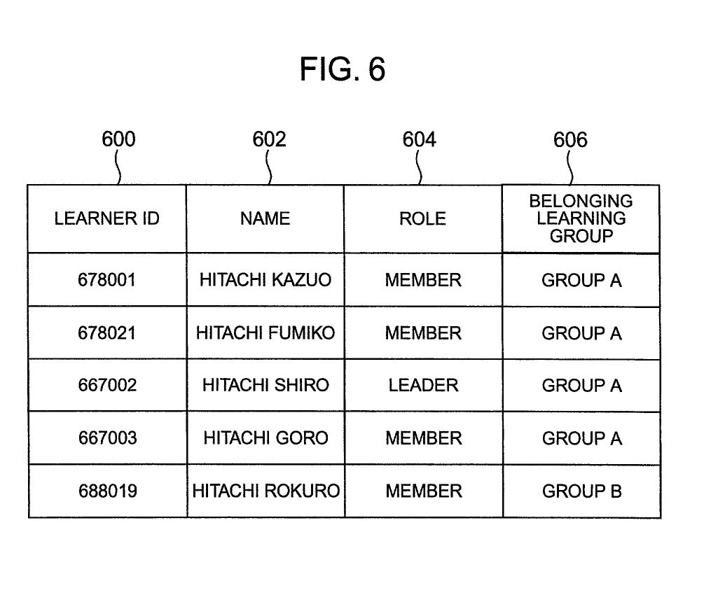

FIG. 6 shows an example of the learning group data 120. In the learning group data 120, information concerning learners registered in a learning group is stored. Stored in learner ID 600 is an identifier (ID) for uniformly identifying a registered learner. Stored in name 602 is a name of the learner. Stored in role 604 is an attribute value of the role played by the learner in the learning group to which the learner belongs. Stored in belonging learning group 606 is a name of the learning group to which the learner belongs. Preferably, the instructor may set the learning group data in advance before learning starts.

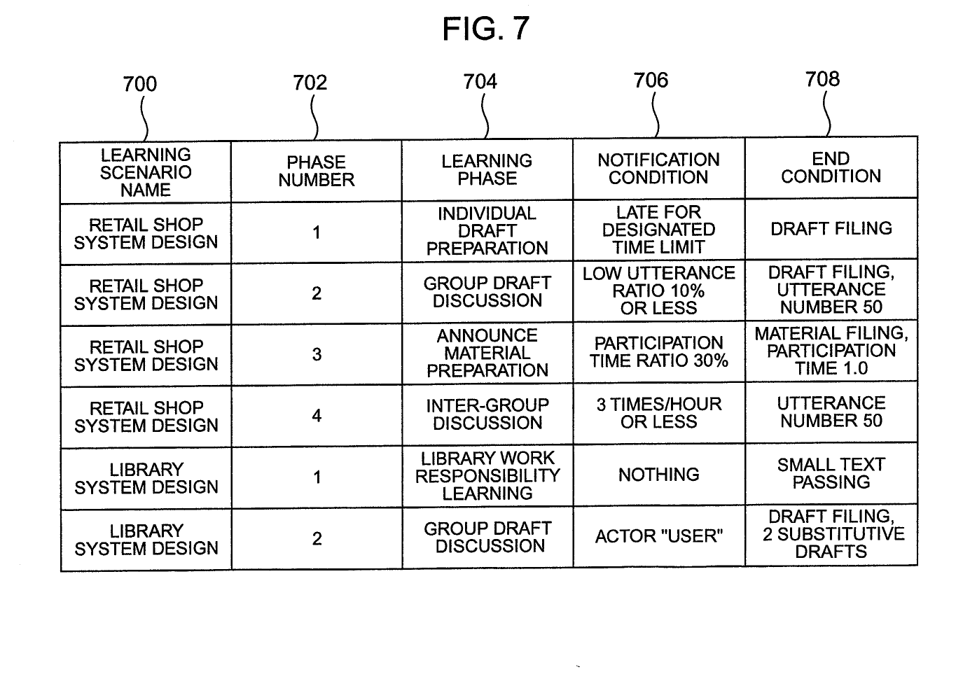

FIG. 7 shows an example of the learning scenario data 124. Stored in learning scenario name 700 is a name of a learning scenario representing a unit of learning contents assigned to a learning group. The substance of learning scenario is divided into learning phases that are more detailed learning steps to ensure that a condition for learning activities can be set learning phase by learning phase. The learning phase is determined by the instructor and is registered in the collaborative learning server 112 in accordance with a request from the instructor client 110. Stored in phase number 702 a numeral indicating the order or sequence of learning in the learning phases constituting the learning scenario. Stored in learning phase 704 is a name of the learning phase. Stored in notification condition 706 is a condition for a notification to be given to the instructor in charge. In other words, when a learning state meeting the condition takes place during learning, a notification asking the instructor in charge to cope with this state is forwarded (for example, by FAX or electronic mail). Stored in end condition 708 is a condition for permitting the learning phase in question to end and to proceed to the next learning phase. The notification condition 706 and end condition 708 are determined by the instructor and they are registered in the collaborative learning server 112 in accordance with a request from the instructor client 110.

An example of data of notification condition 706 will be described. Indicated by “late for filing time limit” is a condition that an individual proposal is not presented to the instructor even a time limit for filing the individual proposal preset by the instructor expires. Indicated by “low utterance ratio 10% or less” is a condition that the ratio between the most frequent utterer's utterance number and the least frequent utterer's utterance number is 10% or less. Indicated by “participation time ratio 30% ” is a condition for a case where there is a learner who participates in learning for only 30% or less of the total time of conducting the learning in a learning group. Indicated by “3 times/hour or less” is a condition that a learner uttered only 3 times or less during a learning time of one hour. Indicated by “actor “user”” is a condition that in the collaborative work tool, an operation of preparing an actor termed “user” is carried out.

An example of data of the end condition 708 will be described. Indicated by “proposal filing” or “material filing” is a condition that a learner presented to the instructor an answer or an announcement material to a problem. Indicated by “utterance number 50”, “participation time 1.0” and “2 substitutive proposals”, respectively, are conditions that the number of utterances in the interactive tool is 50 or more in group total, that learning participation time of individual learners is one hour or more and that the number of proposals prepared in the cooperation tool is 2 or more. When a plurality of conditions exist, either a case where all of the conditions are met or a case where some of the conditions are met may be set.

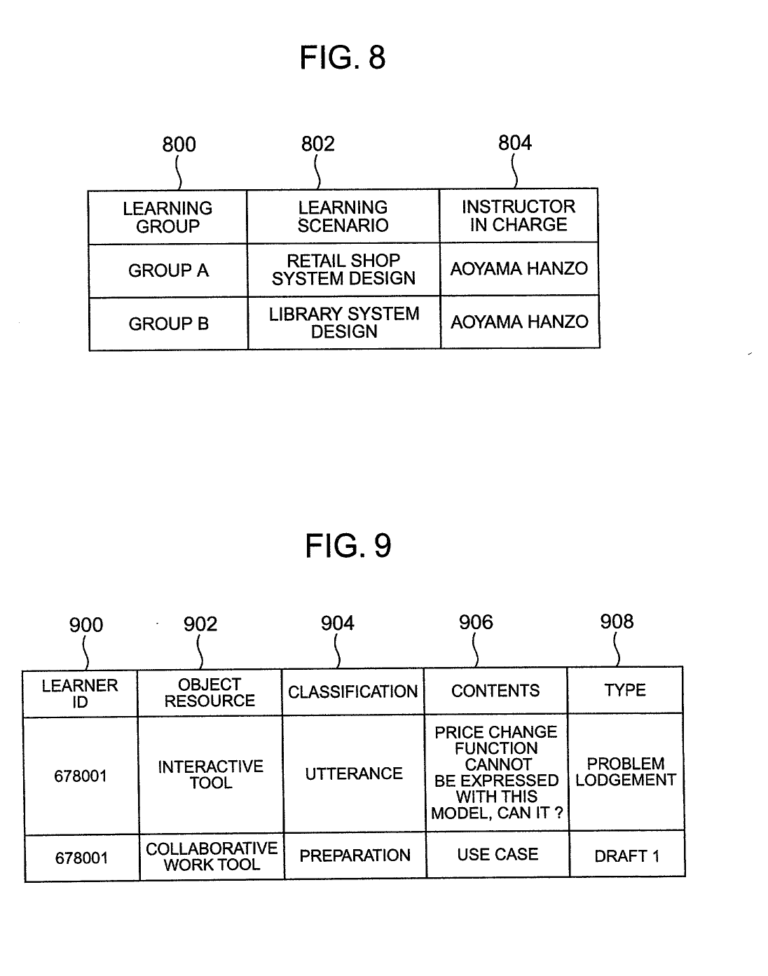

FIG. 8 shows an example of the learning management data 122. In the learning management data 122, learning management information such as a learning scenario to be learnt by a learning group and an instructor in charge is stored. Stored in learning group 800 is a name of a registered learning group. Stored in learning scenario 802 and instructor in charge 804 are a name of a learning scenario to be learnt by the learning group and a name of an instructor in charge of guiding the learning group.

FIG. 9 shows an example of data of an access request from the learner client 100 to the collaborative learning server 112. Learning activities such as reference to interactive data by a group in learning, contribution of utterance and an operation on the collaborative work area for preparation of design draft are all prosecuted in response to the access request. The access request may include a URL for accessing a web server to read a HTML file. Indicated by learner ID 900 is a value of ID inputted by a learner who is conducting learning with a learner client transmitting an access request. Indicated by object resource 902 is a value of a requested object, the object resource being, for example, the interactive tool when the request is for utterance. Indicated by classification 904 is a value indicative of the kind of the request and for example, is “utterance” when the request is for utterance. Indicated by contents 906 is concrete contents of the request. Conversely, indicated by type 908 is a value corresponding to classification that is abstracted by one step. Involved in the utterance are “problem lodgement” during discussion and an opinion “approval” or “opposition”. In this example, the value is one selected by an utterer who determines, from the classification of utterance as above, that his or her own utterance belongs to the value.

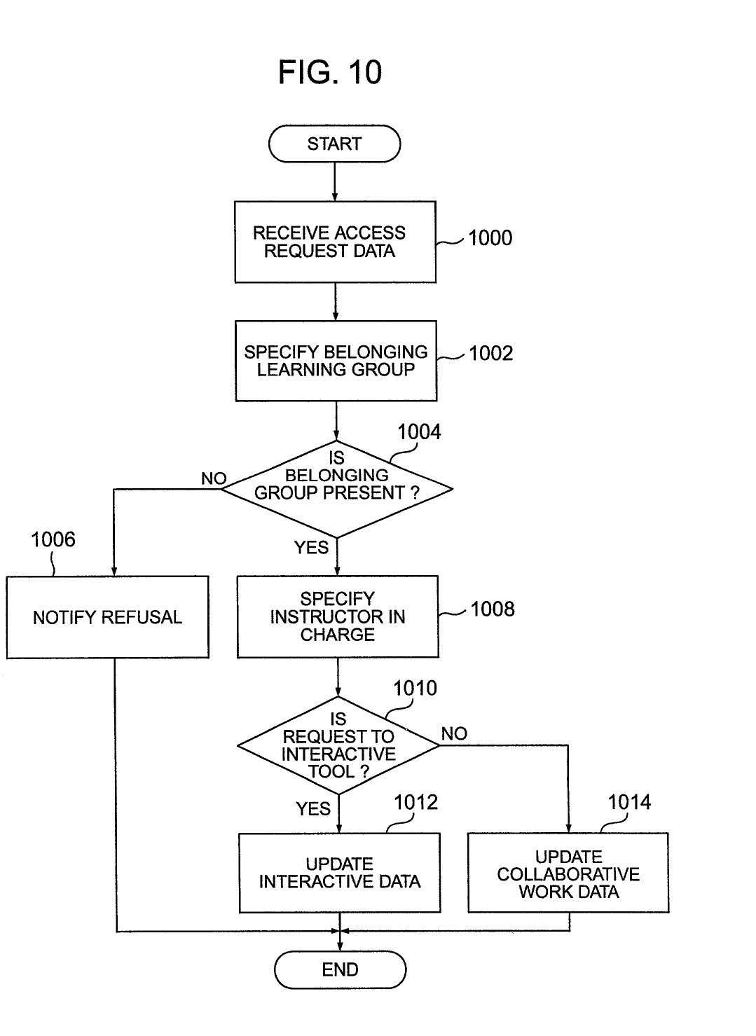

By using the concrete examples of data set forth so far, the shared learning area accessing process 132 will be described in greater detail with reference to FIG. 10. When the shared learning area accessing process 132 is started, data of an access request from a learner client is first received (step 1000). Here, by taking a case where a request of data described by “678001, interactive tool, utterance, with this model . . . , problem lodgement” in line 1 of exemplified data of access request shown in FIG. 9 is received, for instance, the following description will be given.

By using a value “678001” of learner ID in the received access request data and consulting the learning group data 120, it is specified which learning group the learner transmitting the request belongs to(step 1002). In this example, the learner called “Hitach Kazuo” belongs to “group A”. Since, in a step of deciding whether a belonging group exists (step 1004), the presence of the belonging group is determined in this case, the program proceeds to step 1008. If the corresponding learner ID is not present in the learning group data 120 and the belonging group cannot be specified, a notification of refusing the request is returned to the access request transmission source (step 1006) and the process ends.

When the decision result is YES in the step 1004, the learning management data 122 is retrieved by using a value of the specified belonging learning group to acquire corresponding values of learning scenario 802 and instructor in charge 804 (step 1008). Then, since the value of object resource 902 in the received access request data is “interactive tool”, the decision result is YES in step 1010. Accordingly, the utterer name specified in the step 1002 and the contents 906 and type 908 in the received access request data are paired so that data may be added, together with an utterance time, to the group A interactive data 126 (step 1012) and the process may end. In the case of exemplified data in line 2 of the access request data shown in FIG. 9, the decision result is NO in the step 1010 and so, data is added to the group A collaborative work data 128 (step 1014) and the process ends.

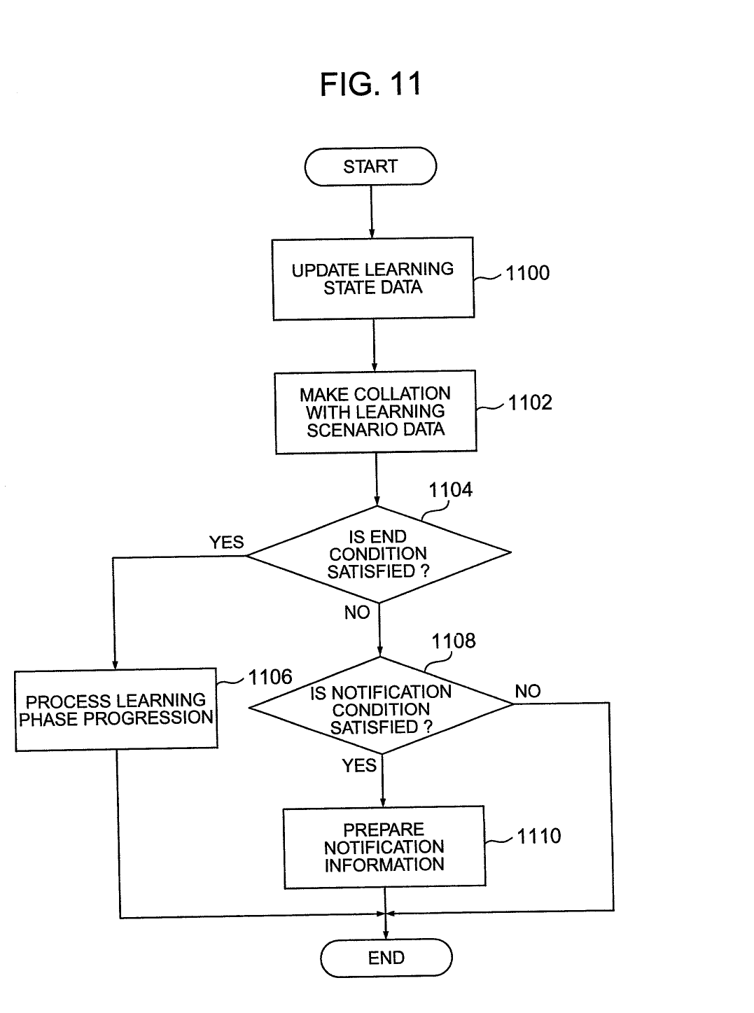

The learning state data updating process 134 will be described in greater detail with reference to FIG. 11. The learning state data updating process 134 is started subsequently to the shared learning area accessing process 132. With the process started, the result of the shared learning area accessing process 132 is first used to update the learning state data 130 (step 1100). In giving a description by way of example of receiving the aforementioned access request of utterance, the learner belonging to the group A has newly uttered and therefore, the value of utterance number 504 of data corresponding to “group A” of group name 500 is incremented. Also, the total utterance number of the uttering learner is incremented and when this learner is the most frequent utterer or the least frequent utterer, the value of most frequent utterer's utterance number 508 or least frequent utterer's utterance number 510 is updated correspondingly.

Subsequently, the updated learning state data 130 is collated with the learning scenario data 124 to decide whether the end condition 708 is not satisfied (step 1102). More particularly, since the value of learning scenario 802 obtained in the step 1008 is “retail shop system design” and the value of present learning phase 502 in the learning state data 130 is “group proposal discussion”, it is decided whether the end condition 708 for the corresponding data (data in line 2 in the example of FIG. 7) in the learning scenario data 124 is not satisfied. In the case of this example, the utterance number does not reach “50” of end condition in the learning state data 130 and consequently, the decision result in step 1104 is NO. In case the decision result is YES, the value of present learning phase 502 in the learning state data 130 is updated to the next phase in accordance with the learning scenario data 124 (step 1106) and the process ends.

When the decision result is NO in the step 1104, it is subsequently decided whether the notification condition 706 in learning scenario data 124 is not satisfied (step 1108). In this example, the low utterance ratio=least frequent utterer's utterance number/most frequent utterer's utterance number=20%, indicating that the notification condition is not satisfied and hence the process, as it is, ends. If the decision result in the step 1108 is YES, notification information to the instructor in charge is prepared in accordance with the corresponding notification condition (step 1110). For example, when the low utterance ratio is below the reference, the notification information includes data of utterance numbers of the individual learners in the group and actual interactive data. The notification information may include information for urging acquisition of the learning scenario data 124. Thus, the instructor in charge receiving the notification can deliberate how to guide the learning group.

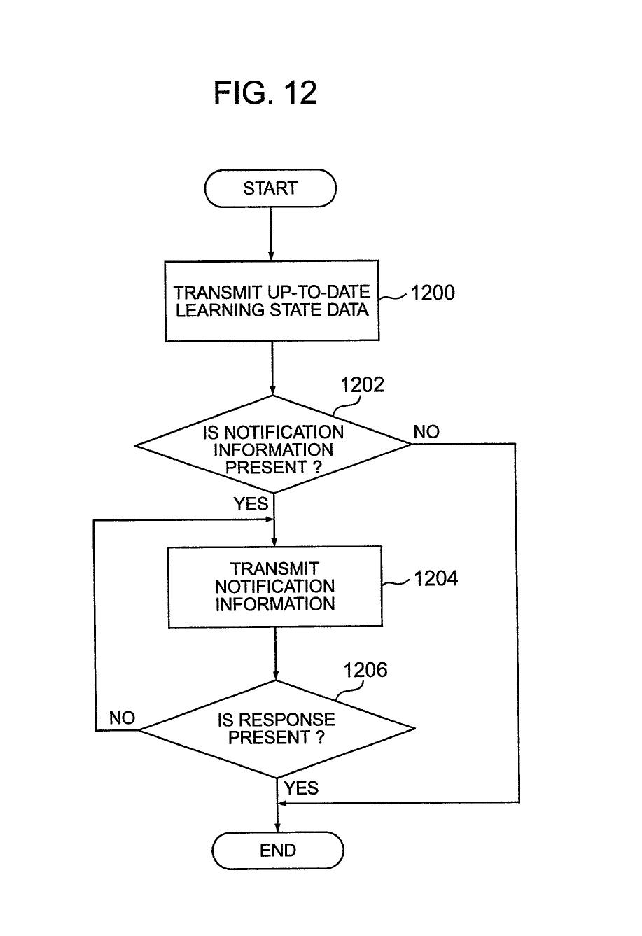

The learning state notifying process 136 will be detailed with reference to FIG. 12. The learning state notifying process 136 is started subsequently to the learning state data updating process 134. With the process started, learning state data 130 of an up-to-date state is first transmitted to the instructor client 110 of the instructor in charge acquired in the step 1008 (step 1200). Thereafter, it is decided whether notification information prepared in the step 1110 is present (step 1202). If the decision result is NO, the process ends. In case the decision result in the step 1202 is YES, the notification information is transmitted to the instructor in charge acquired in the step 1008 (step 1204). If a response to the effect that the notification information is confirmed is returned from the instructor client 110 at a predetermined time lapse (step 1206), the process ends. In case the response is not returned in the step 1206, the program returns to the step 1204 to repeat transmission of the notification information. It is to be noted that the notification information may be transmitted to the learner in place of or in addition to the instructor.

As a concrete method for notification to the instructor, there is available a method in which a mail server is provided and the collaborative learning server asks the mail server to forward the notification information to the instructor by electronic mail. In another method, a WWW server is provided and the collaborative learning server asks the WWW server to display the notification information on WWW client software on the instructor client. In still another method, a program having display means and communication means is provided on the instructor client so that the notification information may be transmitted directly from the collaborative learning server and displayed.

For the learner client, a similar method is available in which a WWW browser is used to transmit a request to the collaborative learning server via a WWW server and receive a response thereto so as to conduct collaborative learning. In another method, a dedicated program having display means and communication means is provided in the learner client so that direct transmission/reception may be carried out between the learner client and the collaborative learning server.

In the foregoing, the example has been described in which the conditions of the total number of times of utterances using the interactive tool and the condition of the deviation in number of times of utterances by the learners are used as the end condition for the learning phase and the notification condition but this does not limit the contents of the end and notification conditions.

As in an example in line 4 in FIG. 7, when the discussion in the learning group is sluggish, a notification may be given to the instructor in charge. In this example, when the utterance number during a learning lapse time of one hour falls below 3, the notification is forwarded. In this case, the instructor receiving the notification can give guidance by transmitting an advice to a learner playing the role of a leader with a view to activating the discussion or by reorganizing groups to enable two groups to debate their drafts mutually.

As in the case of data example in line 3 in FIG. 7, time for participation in learning may be a condition. In this example, when a learner exist having a participation time short of 30% of the learning lapse time, a notification is given to the instructor in charge with a view to preventing work for preparation of announcement materials from being left up to a small number of learners. When receiving this notification, the instructor can give guidance for preventing learning activities from being biased to part of the learners through a method of transmitting instructions to urge learners in nonparticipation in learning to participate in it or of changing a right to operate a material preparation tool so as to cause other learners to be conditioned to participate in learning. Further, there is a condition that unless all learners participate in learning for one hour or more, the advance to the next learning phase by filing materials is not permitted.

As in an example in line 6 in FIG. 7, preparation of a plurality of substitutive drafts and discussion based thereon can be imposed in order that a problem can be debated in group discussion from various viewpoints. This example sets an end condition that unless two or more drafts are prepared and discussed, the advance to the next learning phase is not permitted.

It is also possible to set mistakes in learning expected to be made in the course of learning in order that when such a state takes place, a notification is forwarded to the instructor. An example in line 6 of notification condition 706 in FIG. 7 indicates a condition that when an object called “user” acting as actor having relation to input/output to/from the system is prepared in the collaborative work tool, a notification is given to the instructor. For example, when in the case of studying a given problem, the instructor assumes that it is too vague to extract a participant as expressed by “user”, such a condition is set and detected, thereby ensuring that a guidance can be conducted at that time point by considering a more concrete participant in the learning group for studying the problem.

Further, when forwarding a notification to the instructor, data indicative of a time point at which a learning state satisfying the aforementioned notification condition occurs can be included in notification data, so that the instructor client receiving the notification can be permitted to reproduce and display states of the interactive tool and collaborative work tool at that time point. This enables the instructor to grasp the learning state in advance and then guide the learning group.

Preferably, the processing programs and data in the embodiments of the invention are transmittable on the network or storable in a recording medium readable by the computer (CE-ROM, DVD-ROM or the like) or another memory medium (for example, database server, memory or the like).

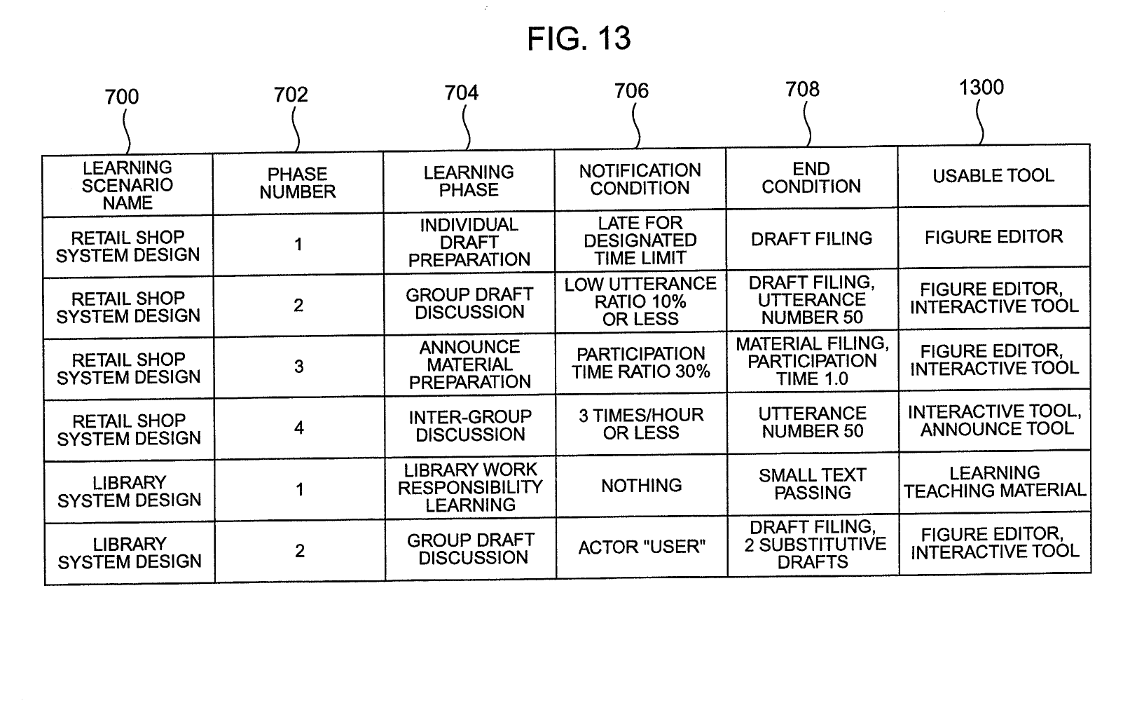

While in the foregoing embodiment the tool used for collaborative learning is exemplified as being the collaborative work tool adapted to prepare drawings by sharing the screen with the interactive tool, various kinds of learning resources utilized for the collaborative learning tool other than the above may be conceivable. Conceivably, for example, a bulletin board system may be used for supporting an asynchronous interactive environment or the TV conference function may be utilized for the purpose of making a motive environment more plenteous. There is a possibility that various kinds of teaching materials will be used depending on themes of learning. In case these various learning resources are all placed in usable condition, learners will possibly be confused and therefore, the instructor may set a utilizable learning resource in accordance with a given learning theme. To this end, a data item of usable tool 1300 is provided in the learning scenario data 124 as shown in FIG. 13. In each learning phase, utilization is limited to only the learning resource set in the usable tool 1300. Accordingly, the shared learning area accessing process 132 also carries out a process in which it is decided whether an access request received from the learner client corresponds is directed to the learning resource designated by the usable tool 1300.

In the embodiments of the invention, the instructor sets a condition for learning activities necessary for obtaining the sufficient learning effects as the end condition in respect of each learning step of collaborative learning to enable the collaborative learning server to control learning such that the learning cannot proceeds unless the condition is satisfied and hence the collaborative learning can be managed in such a manner that the collaborative learning does not end with the learning activities kept to remain insufficient.

Further, by setting as the notification condition a learning state in which the instructor needs to give guidance for permitting sufficient learning activities to be carried out in the course of each learning step, a notification can be forwarded to the instructor in the event that such a state occurs and therefore, even when being in charge of a plurality of learning groups at a time, the instructor can know the necessity for guidance at suitable timing.

Further, since, in the instructor client receiving the notification, states of the interactive tool and collaborative work tool in the learning group at the time that the state needing the guidance occurs are indicated, the instructor can grasp the learning state of the group in advance and then guide the group.

It should be further understood by those skilled in the art that the foregoing description has been made on embodiments of the invention and that various changes and modifications may be made in the invention without departing from the spirit of the invention and scope of the appended claims.

1. A system for managing a collaborative learning state among a plurality of learners, comprising:
a memory storing collaborative learning data shared by said plurality of learners; and
a processor which detects requests for accessing said collaborative learning data in correspondence with learners and calculating the number of access requests in correspondence with said learners.

2. A system according to claim 1, wherein said processor compares access request numbers of said plurality of learners with each other and notifies a result of the comparison to an instructor for managing said learners and/or said learners in accordance with the comparison result.

3. A system according to claim 1, wherein on the basis of said access request number corresponding to said plurality of learners, said processor calculates the ratio of an access request number of one of said plurality of learners who has the access request number which is relatively large or small to a total of access request numbers of said plurality of learners and notifies a calculation result to an instructor for managing said learners and/or at least a relevant learner in accordance with the calculated ratio.

4. A system according to claim 1, wherein on the basis of said access request number corresponding to said learner, said processor calculates a deviation among said access request numbers of said plurality of learners.

5. A system according to claim 1, wherein said collaborative learning data includes at least one of utterance data of said learner concerning said collaborative learning and substitutive proposal data lodged by said learner.

6. A system according to claim 1, wherein said processor decides in accordance with said access request number corresponding to said learner whether a learning phase set in accordance with a learning step is permitted to advance to the next learning phase.

7. A system according to claim 1, wherein said access request includes a request for write to said collaborative learning data.

8. A method for managing a collaborative learning state among a plurality of learners, comprising the steps of:
storing collaborative learning data shared by said plurality of learners;
detecting a request for storing said collaborative learning data in a memory area in correspondence with a learner; and
calculating the number of storage operations of said collaborative learning data in said memory area in correspondence with said learner.

9. A program executable by a computer for implementing a method of managing a collaborative learning state among a plurality of learners, said method comprising the steps:
storing collaborative learning data shared by said plurality of learners;
detecting a request for storing said collaborative learning data in a memory area in correspondence with a learner; and
calculating the number of storage operations of said collaborative learning data in said memory area in correspondence with said learner.

10. A system for managing a collaborative learning state among a plurality of learners, comprising:
a memory for storing collaborative learning data shared by said plurality of learners; and
a processor for detecting a time point of starting access to said collaborative learning data and a time point of ending the access in correspondence with a learner and calculating a time for said learner to participate in collaborative learning in correspondence with said learner on the basis of said access starting time point and said access ending time point.

11. A system according to claim 10, wherein said processor compares participation times of said plurality of learners with each other and notifies a comparison result to an instructor managing said learner and/or said learner on the basis of the comparison result.

12. A system according to claim 10, wherein on the basis of said access starting time point and said access ending time point, said processor calculates a total of participation times of said plurality of learners, calculates the ratio of a participation time of one of said plurality of learners who has the participation time which is relatively short to said total of participation times, and notifies a calculation result to an instructor managing said learner and/or said learner in accordance with the ratio.

13. A method for managing a collaborative learning state among a plurality of learners, comprising the steps of:
storing collaborative learning data shared by said plurality of learners in a memory area;
detecting a time point of starting access to said memory area and a time point of ending the access in correspondence with a learner; and
calculating a time for said learner to participate in collaborative learning in correspondence with said learner on the basis of said access staring time point and said access ending time point.

14. A program executable by a computer for managing a collaborative learning state among a plurality of learners, comprising:
a step of storing collaborative learning data shared by said plurality of learners in a memory area;
a step of detecting a time point of starting access to said collaborative learning data and a time point of ending access in correspondence with a learner; and
calculating a time for said learner to participate in collaborative learning in correspondence with said learner on the basis of said access starting time point and said access ending time point.

15. A server for a plurality of learner to carry out collaborative learning, comprising:
a first server for providing a web site capable of exchanging information among a plurality of learners in accordance with access requests from a learner; and
a second server for calculating a frequency of the access requests to said web site in correspondence with said learner.

16. A server according to claim 15, wherein said web site includes at least one of a column for receiving input of utterance data of said learner concerning said collaborative learning and a column for receiving input of substitutive proposal data lodged by said learner.

17. A method for a plurality of learners to carry out collaborative learning, comprising the steps of:
providing a web site capable of exchanging information among said plurality of learns to said plurality of learners;
receiving access requests from a learner and updating said web site; and
calculating a frequency of the access request to said web site in correspondence with said learner.

18. A method for managing progress states in collaborative learning of a plurality of learner clients, comprising the steps of:
receiving a request for operation on a learning resource for conducting said collaborative learning from a learner client;
updating learning group state data including learning step data and learning activity data in accordance with said operation request;
consulting learning scenario defining data including progress steps of learning, an end condition for each progress step and a notification condition for an instructor managing said learner;
deciding in correspondence with updating of said learning group state date whether said learning step data and said learning activity data satisfy said end condition or said notification condition;
when it is determined that said end condition is satisfied, updating said learning step data to the next learning step; and
when said notification condition is satisfied, forwarding a notification to said instructor.

19. A method according to claim 18, wherein said end condition includes a time for said learner to participate in said collaborative learning.

20. A method according to claim 18, wherein said end condition includes number of times of utterances given by said learner to said collaborative learning.
